(19) United States
(12) Patent Application Publication
(10) Pub. No.: US 2022/0186809 A1
(43) Pub. Date: Jun. 16, 2022

(54) VIBRATION CONTROL BUSH

(71) Applicant: Toyo Tire Corporation, Itami-shi (JP)

(72) Inventors: Shinji Horibe, Itami-shi (JP); Yuta Iwai, Itami-shi (JP)

(73) Assignee: Toyo Tire Corporation, Itami-shi (JP)

(21) Appl. No.: 17/518,111

(22) Filed: Nov. 3, 2021

(30) Foreign Application Priority Data
Dec. 10, 2020 (JP) 2020-205369

(51) Int. Cl. F16F 15/08; F16F 1/373

(52) U.S. Cl. CPC F16F 15/08; F16F 1/373

(57) ABSTRACT

There is provided a vibration control bush that allows improving durability. Formation of an outer periphery depressed portion 326 in an outer peripheral surface of a main body portion 20 forms a thickness dimension D3 in a radial direction of the main body portion 20 in a region overlapping with a projecting portion 340 in an axis 0 direction to be thinner than a thickness dimension D4 in another region where the projecting portion 340 is not formed. Accordingly, an outer diameter (a thickness in the radial direction) of the main body portion 20 in a compressed state of the projecting portion 340 is allowed to be easily made constant in a circumferential direction. This allows suppressing concentration of stress during the compression of the projecting portions 340 on a part of the main body portion 20, thereby ensuring improving durability of vibration control bushes 310 and 410.

### TECHNICAL FIELD

The present invention relates to a vibration control bush and especially relates to a vibration control bush that can improve durability.

### BACKGROUND ART

There has been a technique that interposes a vibration control bush having a rubber elastic body between washers of respective bolt and nut when a component on a vibration source side and a component on a support side supporting the vibration source are fastened and secured with the bolt and the nut. This type of vibration control bush includes a main body portion and an inserted portion and has a cylindrical shape. The main body portion is sandwiched between a fastened component on the vibration source side or the support side and the washer to provide a vibration control function. The inserted portion is inserted into a through-hole formed in the fastened component.

For example, Patent Literature 1 discloses a technique that forms a projecting portion (a protrusion 116) in an axial end surface of a main body portion (a deflection body 115), pushes the projecting portion with a washer (a washer 402) with a bolt and a nut fastened, and gives precompression. With the technique, even when a rubber of the main body portion deteriorates and an elastic force decreases, restoration of the precompressed projecting portion allows maintaining a contact state with the washer. Accordingly, when a load in an axis direction is repeatedly input, repetitive contact and separation between the main body portion and the washer can be suppressed, and therefore an abnormal noise due to the repetitive contact can be suppressed.

### CITATION LIST

### Patent Literature

Patent Literature 1: Japanese Unexamined Patent Application Publication No. 2020-034120 (for example, paragraph 0026, FIG. 2)

### SUMMARY OF INVENTION

### Technical Problem

As in the above-described prior art, formation of the projecting portion on the axial end surface of the main body portion increases an amount of compression (deformation of the rubber) of the main body portion in a region where the projecting portion is formed. In the region where the amount of compression is large, the main body portion is likely to deform so as to bulge toward outside in a radial direction and stress concentrates on the bulging portion. This has caused a problem of deterioration of durability of the vibration control bush.

The present invention has been made to solve the above-described problem and an object of the present invention is to provide a vibration control bush that allows improving durability.

### Solution to Problem

In order to achieve the object, a vibration control bush of the present invention includes a rubber elastic body configured as a component of any one of a vibration source side and a support side. The vibration control bush is interposed between a pair of washers in a fastening structure. The fastening structure includes a fastened component, a cylindrical tubular member, a pair of the washers, and a bolt and a nut. The fastened component has a through-hole. The cylindrical tubular member is inserted into the through-hole in the fastened component. The pair of washers are disposed on both end sides in an axis direction of the tubular member. The bolt and the nut are fastened to one another with the pair of washers sandwiched therebetween. The vibration control bush is formed in a cylindrical shape including a main body portion and an inserted portion. The main body portion is compressed between the fastened component and the washer during the fastening of the bolt and the nut. The inserted portion is inserted into the through-hole. The main body portion has a first end surface and a second end surface. The first end surface is positioned on the washer side in an axis direction. The second end surface is on a side opposite to the first end surface. A plurality of projecting portions arranged in a circumferential direction are formed in at least one of the first end surface and the second end surface. A thickness dimension in a radial direction of the main body portion in a region overlapping with the projecting portion in the axis direction is formed thinner than a thickness dimension in another region.

### Advantageous Effects of Invention

With the vibration control bush according to the first aspect, since the thickness dimension in the radial direction of the main body portion in the region overlapping with the projecting portion in the axis direction is formed to be thinner than the thickness dimension in the other region, with the projecting portions in the compressed state, the thickness in the radial direction of the main body portion can be easily made constant in the circumferential direction. This allows suppressing concentration of stress during the compression of the projecting portions on a part of the main body portion, thereby bringing an effect that durability of the vibration control bush can be improved.

With the vibration control bush according to a second aspect, in addition to the effect provided by the vibration control bush according to the first aspect, the following effect is provided. The thickness dimension in the radial direction of the main body portion is formed to be a thickest in a region between the plurality of projecting portions in a circumferential direction and is formed to be a thinnest in the region overlapping with the projecting portion in the axis direction. Thus, with the projecting portions in the compressed state, an outer diameter (the thickness in the radial direction) of the main body portion can be easily made constant further in the circumferential direction. Thus, the concentration of the stress during the compression of the projecting portions on a part of the main body portion can be further effectively suppressed, thereby bringing an effect that the durability of the vibration control bush can be improved.

With the vibration control bush according to a third aspect, in addition to the effect provided by the vibration control bush according to the second aspect, the following effect is provided. In the first end surface, a plurality of projecting portions arranged in the circumferential direction are formed. In the second end surface, a plurality of depressed portions arranged in the circumferential direction are formed. Accordingly, in a state before the projecting portions are compressed, a space is formed between a fastened member and the main body portion by the depressed portions. The depressed portion of the main body portion is formed at a position overlapping with the projecting portion in the axis direction. Thus, deformation of the rubber during the compression of the projecting portions can be received at the space (the depressed portions of the main body portion) between the fastened member and the main body portion. This allows suppressing the concentration of the stress during the compression of the projecting portions on a part of the main body portion, thereby bringing an effect that the durability of the vibration control bush can be improved.

With the vibration control bush according to a fourth aspect, in addition to the effect provided by the vibration control bush according to the third aspect, the following effect is provided. A pair of the vibration control bushes are disposed with the fastened member interposed therebetween, and therefore axial end surfaces of the inserted portions of the pair of vibration control bushes are opposed at inside the through-hole of the fastened member. The inserted portion has a plurality of depressed portions formed in an axial end surface and arranged in the circumferential direction. Therefore, in the state before the compression of the projecting portions, a space is formed between the inserted portions of the pair of vibration control bushes by the depressed portions. The depressed portion of the main body portion and the depressed portion of the inserted portion are formed at positions arranged in the axis direction when viewed in the radial direction. Accordingly, the deformation of the rubber during the compression of the projecting portions (when the deformation of the rubber is received at the projecting portions of the main body portion) can be received at the projecting portions of the inserted portion. Thus, a contact between the axial end surfaces of the inserted portions during the compression of the projecting portions can be suppressed, and therefore the concentration of the stress due to the contact on a part of the inserted portion can be suppressed. This brings an effect that the durability of the vibration control bush can be improved.

With the vibration control bush according to a fifth aspect, in addition to the effect provided by the vibration control bush according to the fourth aspect, the following effect is provided. The depressed portion of the main body portion has a depth deeper than a depth of the depressed portion of the inserted portion. The depressed portion of the main body portion has a width dimension in the circumferential direction formed larger than a width dimension of the depressed portion of the inserted portion in the circumferential direction. Thus, the deformation of the rubber during the compression of the projecting portions can be received mainly at the depressed portions of the main body portion. Accordingly, while the depressed portions of the inserted portions are formed to be small by the amount and a rubber volume can be ensured, the contact between the axial end surfaces of the inserted portions during the compression of the projecting portions can be suppressed. By ensuring the rubber volume of the inserted portion, even when a load in the axis direction is repeatedly input, early deterioration of the inserted portion can be suppressed. By suppressing the contact between the inserted portions during the compression of the projecting portions, the concentration of the stress on a part of the inserted portion due to the contact can be suppressed. This brings an effect that the durability of the vibration control bush can be improved.

With the vibration control bush according to a sixth aspect, in addition to the effect provided by the vibration control bush according to the first aspect, the following effect is provided. The main body portion has an inner peripheral surface in which a low friction portion having a friction coefficient lower than a friction coefficient of the rubber elastic body is formed. Therefore, a friction resistance between an outer peripheral surface of the tubular member and an inner peripheral surface of the main body portion can be reduced. Thus, since the main body portion easily slips with respect to the tubular member during the compression of the projecting portions, the main body portion is easily compressed in an intended shape. Accordingly, with the projecting portions in the compressed state, the thickness in the radial direction of the main body portion can be easily made constant further in the circumferential direction, and therefore the concentration of the stress during the compression of the projecting portions on a part of the main body portion can be suppressed. This brings an effect that the durability of the vibration control bush can be improved.

With the vibration control bush according to a seventh aspect, in addition to the effect provided by the vibration control bush according to the first aspect, the following effect is provided. The projecting portions formed in the first end surface of the main body portion project along the inner peripheral surface of the main body portion. Thus, when the projecting portions are compressed with the washers, the projecting portions can be brought into contact with the tubular member. Accordingly, even when a height of the projecting portion is formed to be comparatively high, falling of the projecting portion during the compression can be restricted with the tubular member, thereby ensuring appropriately compressing the projecting portions. This allows suppressing the concentration of the stress during the compression of the projecting portions on a part of the projecting portions and the main body portion, thereby bringing an effect that the durability of the vibration control bush can be improved.

With the vibration control bush according to an eighth aspect, in addition to the effect provided by the vibration control bush according to the seventh aspect, the following effect is provided. The projecting portion has a thickness dimension in a circumferential direction formed to gradually increase from an inner peripheral side to an outer peripheral side. Accordingly, the rubber volume in the outer peripheral side of the projecting portion can be ensured. This allows suppressing the falling of the projecting portions toward the outer peripheral side during the compression of the projecting portions, thereby ensuring further appropriately compressing the projecting portions. Thus, the concentration of the stress during the compression of the projecting portions on a part of the projecting portion and the main body portion can be further effectively suppressed, thereby bringing an effect that the durability of the vibration control bush can be improved.

With the vibration control bush according to a ninth aspect, in addition to the effect provided by the vibration control bush according to the eighth aspect, the following effect is provided. The projecting portion has the thickness dimension in the radial direction formed to gradually increase as approaching the main body portion. Accordingly, the falling of the projecting portions toward the outer peripheral side during the compression of the projecting portions can be further effectively suppressed. Thus, since the projecting portion can be further appropriately compressed, the concentration of the stress during the compression of the projecting portions on a part of the projecting portion and the main body portion can be further effectively suppressed. This brings an effect that the durability of the vibration control bush can be improved.

With the vibration control bush according to a tenth aspect, in addition to the effect provided by the vibration control bush according to the first aspect, the following effect is provided. The plurality of projecting portions include a first projecting portion and a second projecting portion having a height from the first end surface higher than a height of the first projecting portion. The second projecting portion having the height higher than the first projecting portion has an amount of compression larger than (a compression length longer than) that of the first projecting portion. This provides an effect that even when the rubber of the main body portion is deteriorated and an elastic force decreases, restoration of the compressed second projecting portion allows easily maintaining the contact state with the washer. Since the first projecting portion formed between the plurality of second projecting portions in the circumferential direction is also compressed, the concentration of the stress generated by precompression only on the formation region of the second projecting portions can be suppressed. This brings an effect that the durability of the vibration control bush can be improved.

With the vibration control bush according to an eleventh aspect, in addition to the effect provided by the vibration control bush according to the tenth aspect, the following effect is provided. An axial end surface of the second projecting portion has an area formed to be smaller than an area of an axial end surface of the first projecting portion. Accordingly, a contacted area between the washer and the axial end surface of the second projecting portion can be reduced. This brings an effect that even when the rubbers of the main body portion and the projecting portion deteriorate to decrease the elastic force, and assume that the projecting portion repeatedly contacts and separates from the washer, an abnormal noise generated by the repetitive contact can be reduced.

With the vibration control bush according to a twelfth aspect, in addition to the effect provided by the vibration control bush according to the first aspect, the following effect is provided. The main body portion has a ring-shaped groove formed in the second end surface. The groove is formed adjacent to an outer peripheral surface of the inserted portion. Therefore, even when the inserted portion deforms toward inside the through-hole during the compression of the projecting portions, stress generated at a boundary part between the inserted portion and the main body portion can be reduced with the groove. This brings an effect that the durability of the vibration control bush can be improved.

With the vibration control bush according to a thirteenth aspect, in addition to the effect provided by the vibration control bush according to the twelfth aspect, the following effect is provided. The groove in a region overlapping with the projecting portion in the axis direction is formed to have a depth deeper than a depth in another region. Accordingly, with the projecting portions compressed, the depth of the groove can be uniformed in the circumferential direction. Accordingly, when the load in the axis direction is repeatedly input, the stress generated at the boundary part between the inserted portion and the main body portion can be effectively reduced with the groove, thereby bringing an effect that the durability of the vibration control bush can be improved.

With the vibration control bush according to a fourteenth aspect, in addition to the effect provided by the vibration control bush according to the first aspect, the following effect is provided. A part on an inner edge side of a reinforcing member is constituted as a covered portion entirely covered with the inserted portion, and therefore the reinforcing member is not exposed from the axial end surface of the inserted portion. Accordingly, even when the load is repeatedly input in the axis direction, detachment at an interface between the inserted portion and the reinforcing member (the covered portion) can be suppressed. That is, by exposing only the exposed portion on an outer edge side of the reinforcing member from the outer peripheral surface of the main body portion, the reinforcing member can be exposed in a region where stress is less likely to occur comparatively during an input of the load in the axis direction. This brings an effect that the durability of the vibration control bush can be improved.

With the vibration control bush according to a fifteenth aspect, in addition to the effect provided by the vibration control bush according to the fourteenth aspect, the following effect is provided. An end portion of the covered portion positioned on a side opposite to the main body portion side in the axis direction is bent radially inside. Thus, when the load in the axis direction is input, the deformation of the rubber toward an inner peripheral side of the reinforcing member can be restricted by the bent portion of the covered portion. Accordingly, since stress generated at an interface between the rubber and the reinforcing member during the deformation of the rubber can be reduced, this brings an effect that the durability of the vibration control bushes can be improved.

With the vibration control bush according to a sixteenth aspect, in addition to the effect provided by the vibration control bush according to the fifteenth aspect, the following effect is provided. The inserted portion has an inner peripheral depressed portion positioned on an inner peripheral side of the bent portion of the covered portion and depressed to an inner peripheral surface of the inserted portion. Accordingly, an excessive increase in the spring constant in the radial direction can be suppressed. That is, as in the fifteenth aspect, when the end portion of the covered portion is bent radially inside, while the deformation of the rubber toward the inner peripheral side of the reinforcing member when the load is input in the axis direction can be restricted, formation of the bent portion causes an excessively high spring constant in the radial direction in some cases. In contrast to this, in the sixteenth aspect, since the inner peripheral depressed portion is formed in the inner peripheral side of the bent portion of the covered portion, this brings an effect that the excessively high spring constant in the radial direction can be suppressed.

With the vibration control bush according to a seventeenth aspect, in addition to the effect provided by the vibration control bush according to the fourteenth aspect, the following effect is provided. When the ring-shaped protrusion that projects from the inner peripheral surface of the through-hole toward the tubular member side is formed in the fastened member, the covered portion is disposed at a position overlapping with the protrusion in the axis direction. Thus, when the load in the axis direction is input, displacement of the vibration control bush (the deformation of the rubber) toward an inside of the through-hole can be restricted by the catch of the protrusion and the covered portion. This has an effect of allowing improving the spring constant in the axis direction.

With the vibration control bush according to an eighteenth aspect, in addition to the effect provided by the vibration control bush according to the seventeenth aspect, the following effect is provided. The inserted portion has a first ring-shaped projecting portion that projects from an axial end surface of the inserted portion and is formed in a ring shape when viewed in an axis direction. The first ring-shaped projecting portion is formed at a position overlapping with the covered portion in an axis direction. Accordingly, with the main body portion in the compressed state, the first ring-shaped projecting portion is also compressed by being sandwiched between the covered portion and the protrusion of the fastened member. Thus, even when the rubber sandwiched between the covered portion and the protrusion is deteriorated and the elastic force decreases, restoration of the compressed first ring-shaped projecting portion allows maintaining a contact state with the protrusion of the fastened member. Accordingly, repetitive contact and separation between the inserted portion and the protrusion when the load in the axis direction is repeatedly input can be suppressed, and thus this has an effect of an abnormal noise due to repetitive contact can be suppressed.

With the vibration control bush according to a nineteenth aspect, in addition to the effect provided by the vibration control bush according to the seventeenth aspect, the following effect is provided. When the inserted portion is inserted into the through-hole in the fastened member, an inner edge of the reinforcing member is positioned on an inner peripheral side with respect to the protrusion. Therefore, this has an effect that when the load in the axis direction is input, the deformation of the rubber of the protrusion toward the inner peripheral side can be restricted by an inner edge portion of the reinforcing member.

### BRIEF DESCRIPTION OF DRAWINGS

FIG. 1 is a cross-sectional view illustrating a state before a bolt and a nut are fastened in a fastening structure using vibration control bushes in a first embodiment.

FIG. 2 is a cross-sectional view illustrating a state in which the bolt and the nut are fastened in the fastening structure using the vibration control bushes.

FIG. 3 is a perspective view of the vibration control bush.

FIG. 4A is a top view of the vibration control bush viewed in the arrow Iva direction of FIG. 3, and FIG. 4B is a cross-sectional view of the vibration control bush taken along the line IVb-IVb of FIG. 4A.

FIG. 5A is a cross-sectional view of the vibration control bush of a second embodiment, and FIG. 5B is a partial side view of the vibration control bush viewed in the arrow Vb direction of FIG. 5A.

FIG. 6 is a perspective view of a vibration control bush in a third embodiment.

FIG. 7A is a top view of the vibration control bush viewed in the arrow VIIa direction of FIG. 6, and FIG. 7B is a side view of the vibration control bush viewed in the arrow VIIb direction of FIG. 7A.

FIG. 8 is a cross-sectional view illustrating a state before the bolt and the nut are fastened in a fastening structure using vibration control bushes.

FIG. 9 is a cross-sectional view illustrating a state in which the bolt and the nut are fastened in the fastening structure using the vibration control bushes.

FIG. 10A is a cross-sectional view of a vibration control bush of a fourth embodiment, and FIG. 10B is a partial side view of the vibration control bush viewed in the arrow Xb direction of FIG. 10A.

FIG. 11A is a perspective view of a vibration control bush in a fifth embodiment, and FIG. 11B is a perspective view of a reinforcing member.

FIG. 12A is a top view of the vibration control bush viewed in the arrow XIIa direction of FIG. 11, and FIG. 12B is a cross-sectional view of the vibration control bush taken along the line XIIb-XIIb of FIG. 12A.

FIG. 13 is a cross-sectional view illustrating a state before the bolt and the nut are fastened in a fastening structure using vibration control bushes.

FIG. 14 is a cross-sectional view illustrating a state in which the bolt and the nut are fastened in the fastening structure using the vibration control bushes.

### DESCRIPTION OF EMBODIMENTS

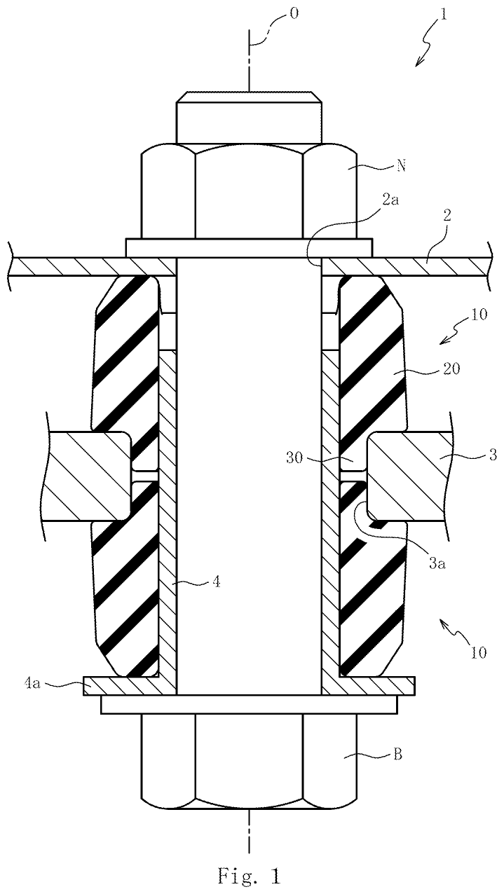

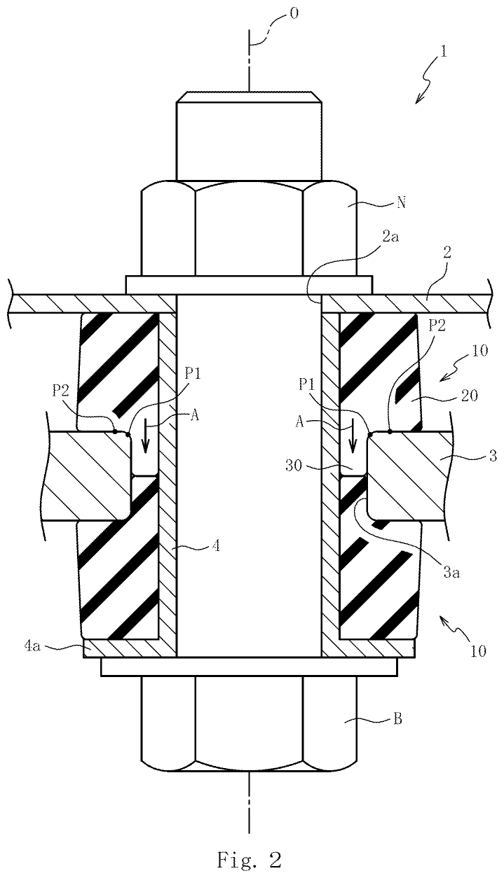

The following will describe preferred embodiments of the present invention with reference to the attached drawings. First, with reference to FIG. 1, a fastening structure 1 using vibration control bushes 10 of a first embodiment will be described. FIG. 1 is a cross-sectional view illustrating a state before a bolt B and a nut N are fastened in the fastening structure 1 using the vibration control bushes 10 in the first embodiment. FIG. 2 is a cross-sectional view illustrating a state in which the bolt B and the nut N are fastened in the fastening structure 1 using the vibration control bushes 10.

As illustrated in FIG. 1, the fastening structure 1 using the vibration control bushes 10 of this embodiment includes a plate-shaped vibration side member 2, which is a component on a vibration source side, such as an engine (or a component constituting a vibration controller that performs vibration absorption on the vibration source). Note that, in this embodiment, while the vibration side member 2 functions as a washer of the nut N, the vibration side member 2 may be a member different from the washer (the washer is separately disposed).

A support side member 3 supporting the above-described vibration source is constituted of a vehicle body frame and the like, and the vibration side member 2 is fastened and secured to the support side member 3 with the bolt B and the nut N. The plate-shaped support side member 3 has a through-hole 3a, and a cylindrical tubular member 4 is inserted into the through-hole 3a. A ring-shaped flange portion 4a projects out to the outside in a radial direction from an end portion in an axis O direction (an end portion on the lower side in FIG. 1) of a tubular member 4. the flange portion 4a is a part that functions as a washer of a head of the bolt B.

The bolt B inserted from the flange portion 4a side of the tubular member 4 is inserted into the through-hole 3a in the support side member 3 and a through-hole 2a in the vibration side member 2, and the nut N is fastened to a shaft portion of the bolt B projecting from the through-hole 2a of the vibration side member 2 to fasten the vibration side member 2 and the support side member 3. With the bolt B and the nut N fastened in the fastening structure 1 of this embodiment, a pair of vibration control bushes 10 are sandwiched between the vibration side member 2 and the support side member 3, and between the support side member 3 and the flange portion 4a of the tubular member 4.

The vibration control bush 10 includes a main body portion 20 sandwiched between the vibration side member 2 (the flange portion 4a) and the support side member 3 and an inserted portion 30 inserted into the through-hole 3a in the support side member 3. The main body portion 20 is formed in a cylindrical shape, and the cylindrical inserted portion 30 projects from the end portion in the axis O direction of the main body portion 20. By integrally forming these main body portion 20 and inserted portion 30 using a rubber elastic body, the cylindrical-shaped vibration control bush 10 is configured.

The inserted portion 30 has an outer diameter formed to be same as or slightly larger an inner diameter of the through-hole 3a in the support side member 3 such that the inserted portion 30 is insertable into the through-hole 3a. On the other hand, since an outer diameter of the main body portion 20 is formed larger than the inner diameter of the through-hole 3a in the support side member 3, when the inserted portion 30 is inserted into the through-hole 3a, the main body portion 20 gets caught on the support side member 3 (an edge portion on the through-hole 3a side).

The main body portion 20 and the inserted portion 30 have inner diameters formed to be same as or slightly smaller than the outer diameter of the tubular member 4 such that the tubular member 4 is insertable into the inner peripheral sides of the main body portion 20 and the inserted portion 30. Accordingly, the tubular member 4 and the bolt B are inserted into the pair of vibration control bushes 10 getting caught on the edge portion of the through-hole 3a in the support side member 3 and the nut N is fastened to the bolt B projecting from the through-hole 2a in the vibration side member 2. Thus, the vibration control bushes 10 are squashed by the vibration side member 2 (the flange portion 4a) and the support side member 3 and precompression is given (see FIG. 2).

In the following description, the state in which the vibration control bushes 10 are compressed by the vibration side member 2 (the flange portion 4a) and the support side member 3 will be described as “an assembled state of the vibration control bushes” and the same applies to second to fifth embodiments described later. As illustrated in FIG. 2, in a case where a load (a vibration) in the axis O direction or the radial direction is input by giving the precompression to the main body portion 20 and the inserted portion 30 of the vibration control bush 10, the precompressed main body portion 20 and inserted portion 30 restore their original shapes. Accordingly, during the input of the load (the vibration) as well, the vibration control bushes 10 can be in close contact with the respective members of the vibration side member 2, the support side member 3, and the tubular member 4. This allows suppressing an abnormal noise due to repetitive separation and contact between each member and the vibration control bush 10, and allows reducing (damping) vibrations transmitted from the vibration side member 2 to the support side member 3 with the vibration control bushes 10.

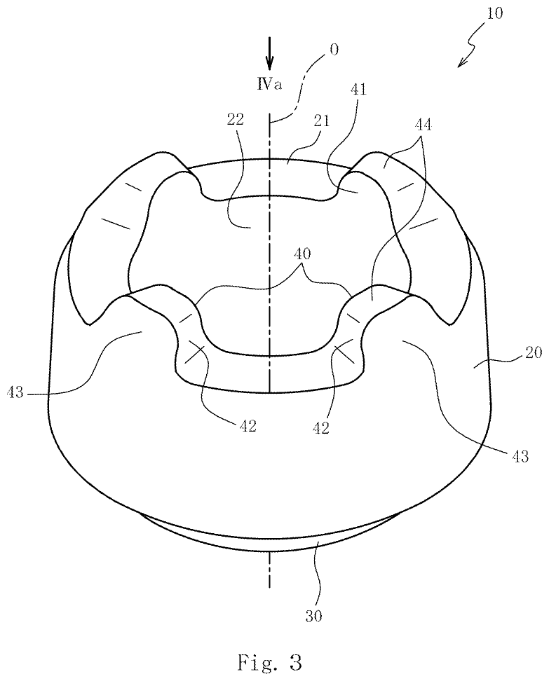

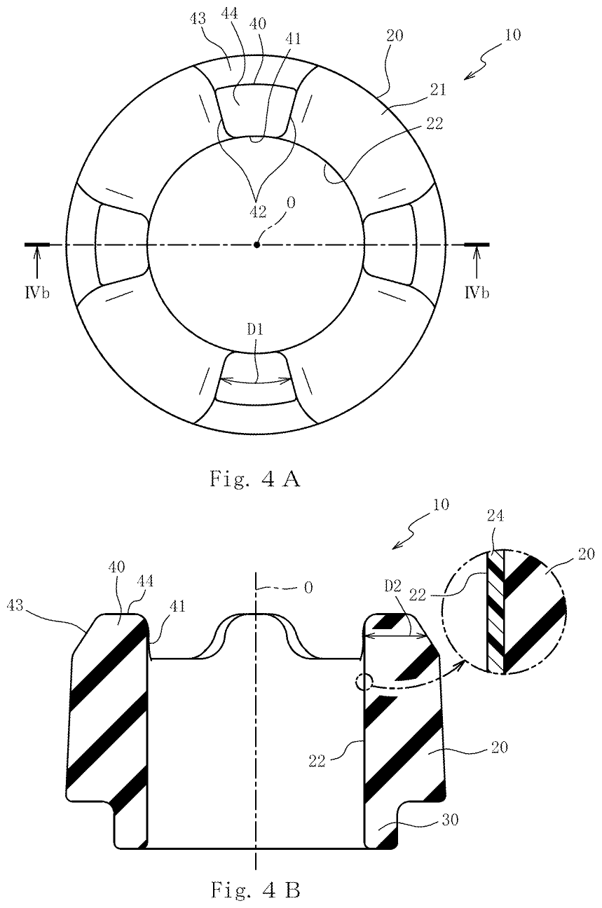

Next, a detailed configuration of the vibration control bush 10 will be described with reference to FIG. 3 and FIG. 4 while the description will be given with reference to FIG. 1 and FIG. 2 as necessary. FIG. 3 is a perspective view of the vibration control bush 10, FIG. 4A is a top view of the vibration control bush 10, and FIG. 4B is a cross-sectional view of the vibration control bush 10 taken along the line IVb-IVb in FIG. 4A.

As illustrated in FIG. 3 and FIG. 4, projecting portions 40 are formed in an end surface 21 on a side opposite to the inserted portion 30 in the axis O direction of the main body portion 20 of the vibration control bush 10. The projecting portion 40 is a projection projecting from the end surface 21 in the axis O direction, and a plurality of (four in this embodiment) the projecting portions 40 are formed to be circumferentially arranged at regular intervals.

The projecting portions 40 project along an inner peripheral surface 22 of the main body portion 20. That is, an inner peripheral surface 41 of the projecting portion 40 is formed along the inner peripheral surface 22 of the main body portion 20, and the inner peripheral surface 41 of the projecting portion 40 and the inner peripheral surface 22 of the main body portion 20 are linearly formed in a cross-sectional view taken along a plane along the axis O (see FIG. 4B). Accordingly, when the projecting portions 40 are compressed by the vibration side member 2 (the flange portion 4a) and the support side member 3 (see FIG. 1 and FIG. 2), the projecting portions 40 can be brought into contact with the outer peripheral surface of the tubular member 4. That is, since the projecting portions 40 can be compressed while the projecting portions 40 are caused to run along the tubular member 4, even when heights of the projecting portions 40 are formed to be comparatively high, falling of the projecting portions 40 during compression can be restricted with the tubular member 4. Note that “formed to be comparatively high” means, for example, forming the projecting portions 40 at the heights equal to or more than a projection dimension of the inserted portion 30 from the main body portion 20 (a dimension of the inserted portion 30 in the axis O direction).

In the projecting portion 40, a pair of side surfaces 42 facing the circumferential direction are formed such that an interval between them gradually widens as approaching the outer peripheral side. That is, a width dimension D1 (see FIG. 4A) in the circumferential direction of the projecting portion 40 is formed to gradually widen from the inner peripheral side to the outer peripheral side, and therefore a rubber volume at the outer peripheral side of the projecting portion 40 can be ensured. This allows suppressing falling of the projecting portion 40 toward the outer peripheral side when the projecting portion 40 is compressed.

An outer peripheral surface 43 of the projecting portion 40 is formed in a taper shape that radially expands as approaching the outer peripheral surface of the main body portion 20, and the taper-shaped outer peripheral surface 43 is coupled to the outer peripheral surface of the main body portion 20. Accordingly, a thickness dimension D2 (see FIG. 4B) in the radial direction of the projecting portion 40 is formed to gradually increase as approaching the main body portion 20. This allows suppressing the falling of the projecting portion 40 toward the outer peripheral side when the projecting portion 40 is compressed.

Since an end surface 44 in the axis O direction of the projecting portion 40 is a plane perpendicular to the axis O (radially extends), a force when the projecting portion 40 is compressed is easily applied in the axis O direction. This allows suppressing falling of the projecting portion 40 toward the outer peripheral side when the projecting portion 40 is compressed.

By thus reducing the falling of the projecting portions 40 during compression, the projecting portions 40 can be appropriately compressed, and therefore concentration of the stress during the compression of the projecting portions 40 on a part of the projecting portion 40 and the main body portion 20 can be suppressed. Accordingly, the durability of the vibration control bush 10 can be improved.

As illustrated in the enlarged part in FIG. 4B, a low friction portion 24 having a friction coefficient lower than that of the rubber elastic body constituting the vibration control bush 10 is formed in the inner peripheral surface 22 of the main body portion 20. The low friction portion 24 is formed by performing vulcanization bonding on the main body portion 20 with a Teflon sheet (a mesh and a cloth) or coating Teflon on the inner peripheral side of the main body portion 20. However, as long as the friction coefficient can be lower than that of the rubber elastic body constituting the vibration control bush 10, the low friction portion 24 may be formed by another processing method.

Thus forming the low friction portion 24 in the inner peripheral surface 22 of the main body portion 20 allows reducing a friction resistance between the outer peripheral surface of the tubular member 4 (see FIG. 1) and the inner peripheral surface 22 of the main body portion 20. Accordingly, abrasion of the inner peripheral surface 22 of the main body portion 20 due to friction with the outer peripheral surface of the tubular member 4 when the load (the vibration) in the axis O direction is repeatedly input in the assembly state (the state in FIG. 2) of the vibration control bushes 10 can be suppressed, and therefore the durability of the vibration control bush 10 can be improved. Further, an abnormal noise due to the friction between the outer peripheral surface of the tubular member 4 and the inner peripheral surface 22 of the main body portion 20 can be suppressed.

Although the illustration is omitted, since the configuration equivalent to the low friction portion 24 is also formed in the inner peripheral surface of the inserted portion 30 and the inner peripheral surface 41 of the projecting portion 40, the friction resistance with the outer peripheral surface of the tubular member 4 can be reduced. Accordingly, abrasion of the inserted portion 30 and the projecting portion 40 due to friction with the outer peripheral surface of the tubular member 4 when the load (the vibration) in the axis O direction is repeatedly input in the assembly state (the state in FIG. 2) of the vibration control bushes 10 can be suppressed, and an abnormal noise due to the friction can be suppressed. Further, when the projecting portion 40 is compressed from the state illustrated in FIG. 1, the projecting portion 40 easily slips with respect to the outer peripheral surface of the tubular member 4, and therefore the projecting portion 40 can be appropriately compressed.

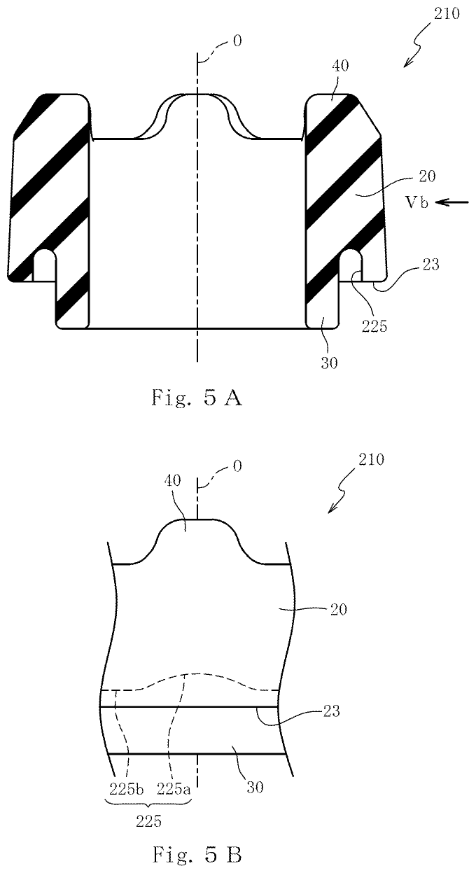

Here, as indicated by the arrows A in FIG. 2, when the load in the axis O direction is input with the vibration control bushes 10 in the assembled state, due to deformation of the rubbers of the main body portion 20 and the projecting portions 40, the inserted portion 30 is pushed into the through-hole 3a in the support side member 3. At the time, stress concentrates on a boundary P1 between the main body portion 20 and the inserted portion 30 and a crack is likely to occur. A configuration of a second embodiment that suppresses the crack will be described with reference to FIG. 5. Identical reference numerals are given to parts identical to those of the above-described first embodiment, and description thereof will be omitted.

FIG. 5A is a cross-sectional view of a vibration control bush 210 of the second embodiment, and FIG. 5B is a partial side view of the vibration control bush 210 viewed in the arrow Vb direction of FIG. 5A. FIG. 5A illustrates a cross-sectional surface taken along the plane along the axis O, and FIG. 5B illustrates a bottom surface (a top) of a groove 225 by the dashed line.

As illustrated in FIG. 5A, the vibration control bush 210 includes the groove 225 formed in the main body portion 20. The groove 225 is a ring-shaped groove depressed toward an end surface 23 (the end surface 23 positioned on the inserted portion 30 side) of the main body portion 20 in the axis O direction. The groove 225 is depressed toward the projecting portion 40 side along the outer peripheral surface of the inserted portion 30. That is, since the groove 225 is formed adjacent to the outer peripheral surface of the inserted portion 30, the stress generated at the boundary P1 (see FIG. 2) between the main body portion 20 and the inserted portion 30 can be reduced with the groove 225. This allows improving the durability of the vibration control bush 210.

As illustrated in FIG. 5B, the groove 225 has curving portions 225a having a curved shape projecting toward the projecting portion 40 side in a groove bottom surface. Although the illustration will be omitted, a plurality of (four positions in the groove 225 in this embodiment) the curving portions 225a are circumferentially formed at regular intervals, and end portions in the circumferential direction of the plurality of curving portions 225a are coupled to one another with linear portions 225b. The linear portion 225b is a part where a depth of the groove 225 is constant along the circumferential direction.

That is, while the depth of the groove 225 before the projecting portion 40 is compressed (the depth from the end surface 23) deepens in a region overlapping with the projecting portion 40 in the axis O direction, the depth is formed to be shallow in another region where the groove 225 does not overlap with the projecting portion 40 in the axis O direction. Accordingly, the deformation of the rubber during the compression of the projecting portion 40 can be received at the curving portion 225a where the depth of the groove 225 is deep. Thus, the depth of the groove 225 after the compression of the projecting portion 40 can be uniformed in the circumferential direction (blocking the groove 225 due to the compression of the projecting portion 40 can be suppressed). Accordingly, the stress generated at the boundary P1 (see FIG. 2) between the main body portion 20 and the inserted portion 30 can be effectively reduced with the groove 225.

The description will be given returning to FIG. 1 and FIG. 2. When the main body portion 20 and the projecting portions 40 are compressed between the vibration side member 2 (the flange portion 4a of the tubular member 4) and the support side member 3, an amount of deformation of the rubber increases at the regions where the projecting portions 40 are formed. Accordingly, with the projecting portions 40 compressed (the state in FIG. 2), a cross-sectional shape of the main body portion 20 taken along a direction perpendicular to the axis O is not a true circle but is likely to be a shape in which only the formation regions of the projecting portions 40 bulge and distort. Since stress is likely to concentrate on the bulged parts, a problem arises in that the durability of the vibration control bush 10 is deteriorated. Further, when only a part of the region of the main body portion 20 bulges due to the compression of the projecting portions 40, the bulged part interferes with another surrounding component in some cases. To suppress the interference, arrangement spaces of the vibration control bushes 10 need to be increased. When the projecting portions 40 are compressed, a friction force at a contact part P2 of the support side member 3 with the main body portion 20 increases. Accordingly, when the load in the radial direction is input in the compressed state, a problem arises in that the friction with the support side member 3 is likely to damage the main body portion 20.

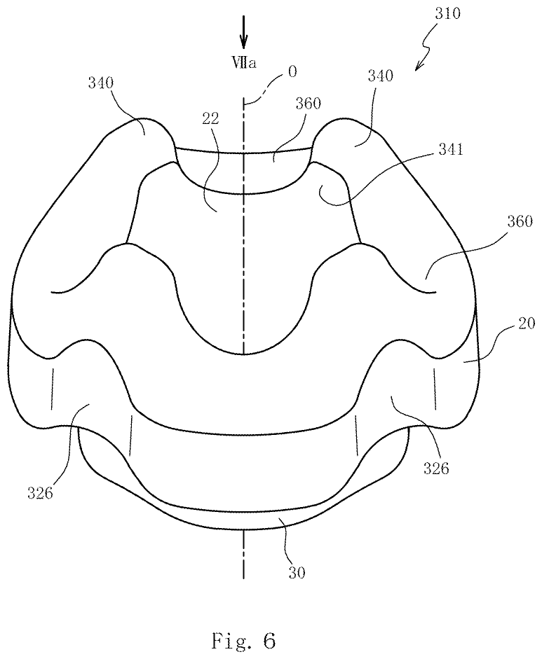

A vibration control bush 310 of a third embodiment that solves these problems will be described with reference to FIG. 6 to FIG. 9. Identical reference numerals are given to parts identical to those of the above-described respective embodiments, and description thereof will be omitted.

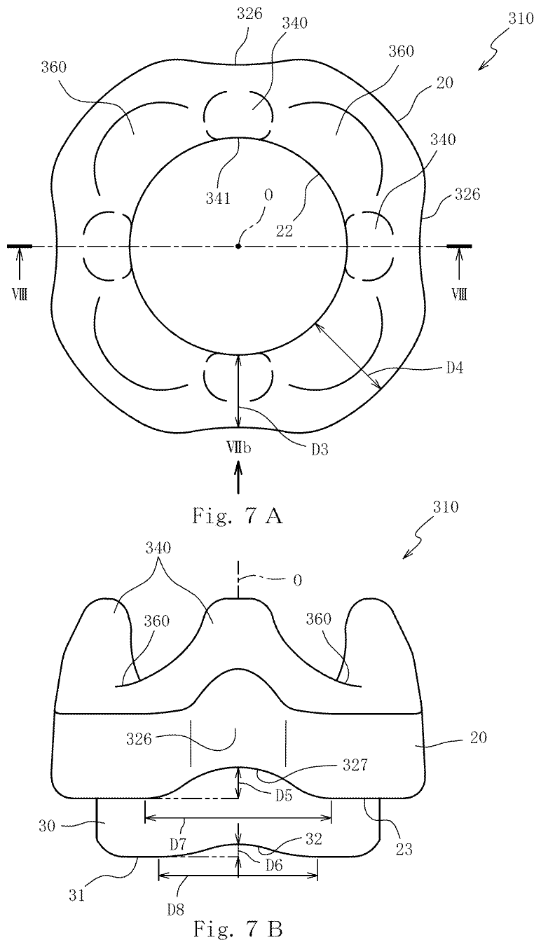

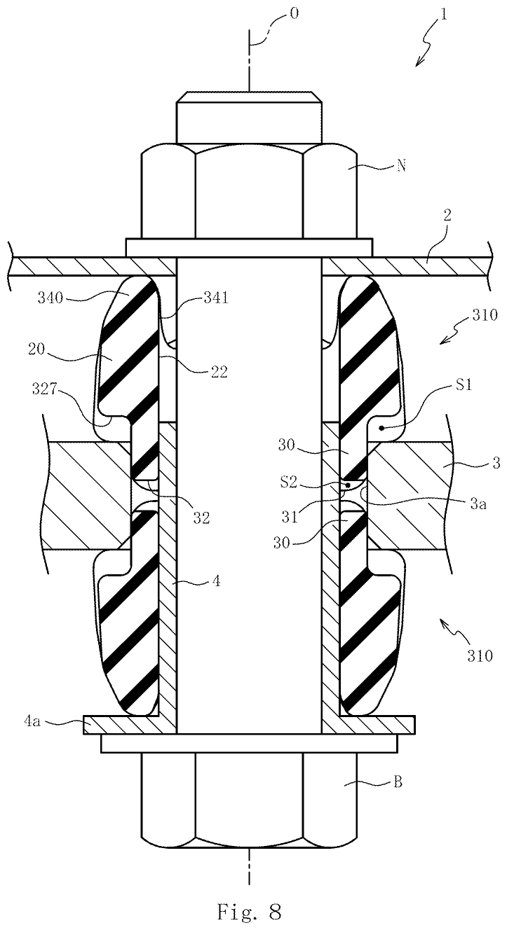

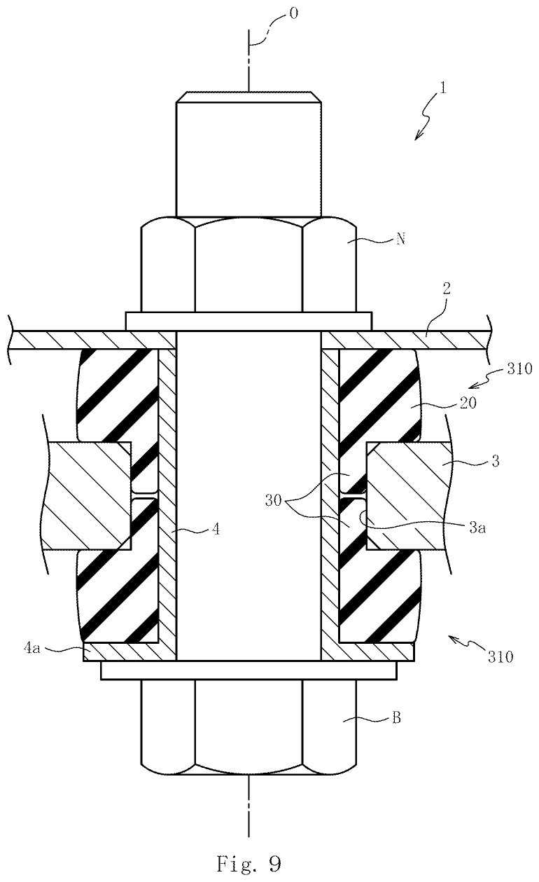

FIG. 6 is a perspective view of a vibration control bush 310 in the third embodiment. FIG. 7A is a top view of the vibration control bush 310 viewed in the arrow VIIa direction of FIG. 6, and FIG. 7B is a side view of the vibration control bush 310 viewed in the arrow VIIb direction of FIG. 7A. FIG. 8 is a cross-sectional view illustrating a state before the bolt B and the nut N are fastened in the fastening structure 1 using the vibration control bushes 310. FIG. 9 is a cross-sectional view illustrating a state in which the bolt B and the nut N are fastened in the fastening structure 1 using the vibration control bushes 310. Note that the cross-sectional surface of the vibration control bush 310 illustrated in FIG. 8 is equivalent to the cross-sectional surface taken along the line VIII-VIII of FIG. 7A.

As illustrated in FIG. 6 and FIG. 7, projecting portions 340 are formed on an end surface on a side opposite to the inserted portion 30 in the axis O direction in the main body portion 20 of the vibration control bush 310 of the third embodiment. The projecting portion 340 is a projection projecting from the main body portion 20 in the axis O direction, and a plurality of (four in this embodiment) the projecting portions 340 are formed to be circumferentially arranged at regular intervals. In this embodiment, a part positioned between the plurality of projecting portions 340 will be described as a depressed portion 360. A bottom surface of the depressed portion 360 is equivalent to the end surface 21 of the main body portion 20 of the first embodiment.

The projecting portions 340 project along the inner peripheral surface 22 of the main body portion 20. That is, an inner peripheral surface 341 of the projecting portion 340 is formed along the inner peripheral surface 22 of the main body portion 20, and, as illustrated in FIG. 8, the inner peripheral surface 341 of the projecting portion 340 and the inner peripheral surface 22 of the main body portion 20 are linearly formed in a cross-sectional view taken along a plane along the axis O. Accordingly, when the projecting portions 340 are compressed by the vibration side member 2 (the flange portion 4a of the tubular member 4) and the support side member 3, the projecting portions 340 can compressed while causing the projecting portions 340 to run along the outer peripheral surface of the tubular member 4. Accordingly, even when the height of the projecting portion 340 is formed to be comparatively high, precompression can be appropriately given to the projecting portion 340.

Since the end surface in the axis O direction (the distal end surface) of the projecting portion 340 has a curved surface, a contacted area between the vibration side member 2 (the flange portion 4a of the tubular member 4) and the end surfaces in the axis O direction of the projecting portions 340 can be reduced. Accordingly, with the vibration control bushes 310 in the assembled state (the state in FIG. 9), even when the rubbers of the main body portion 20 and the projecting portions 340 deteriorate to decrease the elastic force, and assume that the projecting portions 340 repeatedly contact and separate from the vibration side member 2, an abnormal noise generated by the repetitive contact can be reduced.

As illustrated in FIG. 6 and FIG. 7, the plurality of projecting portions 340 are coupled one another with the depressed portion 360, and the depressed portion 360 radially extends from the outer peripheral surface to the inner peripheral surface 22 of the main body portion 20. Since the depressed portion 360 is a curved surface depressed toward the inserted portion 30 side, concentration of stress when the projecting portions 340 are compressed on a region between the projecting portions 340, that is, a part of the depressed portions 360, can be suppressed. Accordingly, the durability of the vibration control bush 310 can be improved.

Outer periphery depressed portions 326 extending in the axis O direction from the end surface 23 of the main body portion 20 to the outer peripheral surfaces of the projecting portions 340 are formed in the outer peripheral surface of the main body portion 20, and the outer periphery depressed portions 326 are constituted of curved surfaces depressed toward the axis O side. By forming the outer periphery depressed portion 326, a thickness dimension D3 in the radial direction of the main body portion 20 at a region overlapping with the projecting portion 340 in the axis O direction is formed thinner than a thickness dimension D4 at another region. While the illustration is omitted, in the assembled state (the state in FIG. 9) of the vibration control bushes 310, bulging only the regions (the regions where the projecting portions 340 are formed) of a part of the main body portion 20 toward outside in the radial direction can be suppressed. That is, a cross-sectional (a cross-sectional surface in a plane perpendicular to the axis O) shape of the main body portion 20 in the compressed state of the projecting portions 340 can be close to a true circle.

The thickness dimensions D3 and D4 in the radial direction of the main body portion 20 are formed so as to be the thickest at an intermediate position (the position indicated by D4) between the projecting portions 340 in the circumferential direction, and are formed to be gradually thin from the intermediate position to the position (the position indicated by D3) overlapping with the projecting portion 340 in the axis O direction. This allows further effectively suppressing bulging only the regions of a part of the main body portion 20 toward outside in the radial direction with the projecting portions 340 in the compressed state (the state in FIG. 9).

Thus, making the cross-sectional shape of the main body portion 20 with the projecting portions 340 in the compressed state close to the true circle allows suppressing concentration of the stress during the compression of the projecting portions 340 on a part of the main body portion 20. Accordingly, the durability of the vibration control bush 310 can be improved. Further, compared with a case in which only a part of the regions deform so as to bulge in the circumferential direction of the main body portion 20, an interference of the main body portion 20 after compression with another surrounding component can be suppressed. Accordingly, an arrangement space of the vibration control bushes 310 can be reduced.

Processing equivalent to the low friction portion 24 (see FIG. 4B) of the first embodiment is performed on the inner peripheral surfaces 22 and 341 of the main body portion 20 and the projecting portions 340. In view of this, when the projecting portions 340 are compressed from the state of FIG. 8, since the main body portion 20 and the projecting portions 340 easily slip with respect to the tubular member 4, the main body portion 20 is likely to be compressed in an intended shape. Accordingly, the thickness dimension in the radial direction of the main body portion 20 with the projecting portions 340 in the compressed state (the state in FIG. 9) can be further made constant easily in the circumferential direction. Since a friction with the outer peripheral surface of the tubular member 4 allows suppressing abrasion of the inner peripheral surfaces 22 and 341 of the main body portion 20 and the projecting portions 340, the durability of the vibration control bushes 310 can be improved. Further, an abnormal noise due to the friction between the outer peripheral surface of the tubular member 4 and the inner peripheral surfaces 22 and 341 of the main body portion 20 and the projecting portions 340 can be suppressed.

As illustrated in FIG. 7B, depressed portions 327 depressed toward the projecting portion 340 side are formed in the end surface 23 of the main body portion 20 on the inserted portion 30 side, and the depressed portion 327 radially extends from the outer peripheral surface of the main body portion 20 to the outer peripheral surface of the inserted portion 30 (an inner edge of the end surface 23). Accordingly, as illustrated in FIG. 8, in a state before the projecting portion 340 is compressed, a space S1 is formed between the support side member 3 and the main body portion 20 with the depressed portion 327. Accordingly, the deformation of the rubber when the main body portion 20 is compressed can be received by the space S1 (the depressed portion 327) between the support side member 3 and the main body portion. Accordingly, with the main body portion 20 in the compressed state illustrated in FIG. 9, the load acting on the support side member 3, that is, the friction force of the contact part between the support side member 3 and the main body portion 20 can be reduced. Therefore, since damage of the main body portion 20 due to the friction with the support side member 3 when the load in the radial direction is input with the vibration control bushes 310 in the assembled state (the state in FIG. 9) can be suppressed, the durability of the vibration control bushes 310 can be improved.

Although the illustration is omitted, a plurality of the depressed portions 327 are circumferentially formed at regular intervals, and the plurality of respective depressed portions 327 are formed at positions overlapping with the plurality of projecting portions 340 in the axis O direction. In view of this, as illustrated in FIG. 8 and FIG. 9, the deformation of the rubber when the projecting portions 340 are compressed can be received by the spaces S1 (the depressed portions 327) between the support side member 3 and the main body portion 20. Accordingly, since concentration of the stress by the compression of the projecting portions 340 on a part of the main body portion 20 can be suppressed, the durability of the vibration control bushes 310 can be improved.

As illustrated in FIG. 7B, a depth D5 of the depressed portion 327 is formed to be the deepest at the position overlapping with the projecting portion 340 in the axis O direction, and the deformation of the rubber when the projecting portions 340 are compressed is likely to be received at the depressed portion 327. This allows further effectively suppressing the concentration of the stress by the compression of the projecting portions 340 on a part of the main body portion 20.

Additionally, the depressed portion 327 has a curved surface depressed toward the projecting portion 340 side, and therefore concentration of the stress during the compression of the main body portion 20 on a part of the depressed portions 327 can be suppressed. Accordingly, the durability of the vibration control bushes 310 can be improved.

In this embodiment, while a part where the depressed portion 327 is not formed is a flat surface in the end surface 23 of the main body portion 20, the flat surface may be configured as a curved surface projecting toward the inserted portion 30 side (the lower side in FIG. 7B). Thus, the end surface 23 of the main body portion 20 is a waveform of an unevenness shape, and therefore concentration of the stress during the compression of the main body portion 20 on a part of the end surface 23 can be further effectively suppressed.

As illustrated in FIG. 8, since a pair of the vibration control bushes 310 are disposed with the support side member 3 interposed therebetween, the inserted portions 30 of the pair of vibration control bushes 310 are opposed inside the through-hole 3a. In the case, like the inserted portions 30 of the first embodiment (see FIG. 1), in the case where the end surfaces in the axis O direction of the inserted portions 30 are the flat surfaces, due to the deformation of the rubber when the main body portions 20 are compressed, a pair of end surfaces 31 are in contact with one another in some cases (see FIG. 2). The contact of the end surfaces 31 of the inserted portions 30 causes a problem that stress is likely to concentrate on the contact part and a problem that a spring constant in the axis O direction worsens (excessively increases). In contrast to the, in this embodiment, as illustrated in FIG. 7B, a plurality of depressed portions 32 arranged circumferentially are formed in the end surface 31 of the inserted portion 30, and the depressed portions 32 radially extend from the outer peripheral surface to the inner peripheral surface of the inserted portion 30. In view of this, as illustrated in FIG. 8, in a state before the compression of the projecting portions 340, a space S2 to receive the deformation of the rubber can be formed between the pair of inserted portions 30. Since the depressed portion 32 forming the space S2 is formed at a position overlapping with the projecting portion 340 in the axis O direction, the deformation of the rubber when the projecting portion 340 is compressed can be received at the space S2 (the depressed portions 32) between the end surfaces 31 of the inserted portions 30 (see FIGS. 8 and 9). Accordingly, since the contact between the end surfaces 31 of the inserted portions 30 during the compression of the projecting portions 340 can be suppressed, the concentration of stress due to the contact on a part of the inserted portions 30 and worsening (excessively increasing) the spring constant in the axis O direction can be suppressed.

Here, as described above, the deformation of the rubber during the compression of the projecting portions 340 is received at the depressed portions 327 of the main body portion 20, and therefore the inserted portion 30 is easily pushed into the through-hole 3a in the region where the depressed portions 327 are formed. Accordingly, in the region, the end surfaces 31 of the pair of inserted portions 30 are likely to be in contact during the compression of the projecting portions 340.

In contrast to this, in this embodiment, the depressed portion 32 of the inserted portion 30 is formed at a position having the same phase as the depressed portion 327 of the main body portion 20 in the circumferential direction. That is, as illustrated in FIG. 7B, when the vibration control bush 310 is viewed in the radial direction, the depressed portion 327 of the main body portion 20 and the depressed portion 32 of the inserted portion 30 are formed at the positions arranged in the axis O direction. In view of this, as illustrated in FIG. 8 and FIG. 9, the deformation of the rubber during the compression of the main body portion 20 (when the deformation of the rubber is received at the depressed portions 327) can be received at the depressed portions 32 of the inserted portion 30. This allows effectively suppressing the contact between the end surfaces 31 of the inserted portions 30 during the compression of the main body portions 20.

As illustrated in FIG. 7B, the depth D5 of the depressed portion 327 of the main body portion 20 is formed deeper than a depth D6 of the depressed portion 32 of the inserted portion 30. Additionally, a width dimension D7 in the circumferential direction of the depressed portion 327 of the main body portion 20 is formed larger than a width dimension D8 in the circumferential direction of the depressed portion 32 of the inserted portion 30. This allows receiving the deformation of the rubber during the compression of the projecting portions 340 mainly at the depressed portions 327 of the main body portion 20. Accordingly, while the depressed portions 32 of the inserted portions 30 are formed to be small by the amount and the rubber volume is ensured, the contact between the end surfaces 31 of the inserted portions 30 in the compressed state (the state in FIG. 9) of the projecting portions 340 can be suppressed.

By ensuring the rubber volume of the inserted portion 30, even when the load (the vibration) in the radial direction is repeatedly input with the vibration control bushes 310 in the assembled state (the state in FIG. 9), early deterioration of the inserted portion 30 can be suppressed.

Since the depressed portion 32 has the curved surface depressed toward the main body portion 20 side, the concentration of the stress during compression of the main body portions 20 on a part of the depressed portions 32 can be suppressed. Accordingly, the durability of the vibration control bushes 310 can be improved.

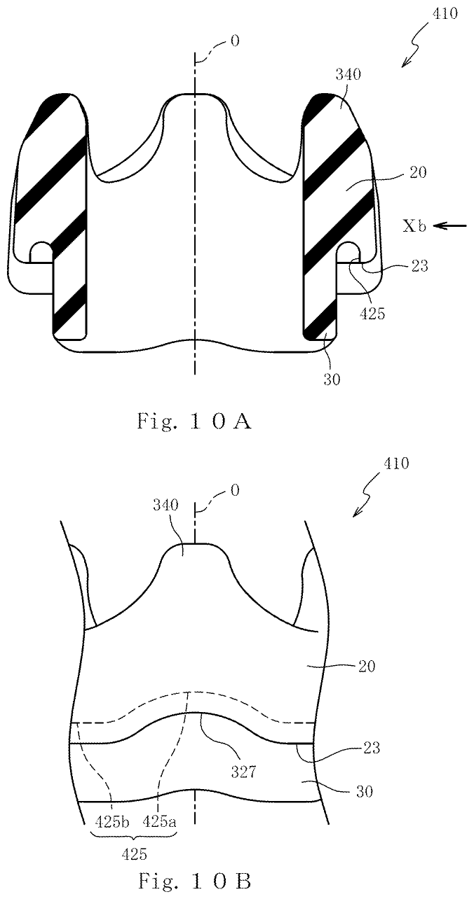

Next, with reference to FIG. 10, a vibration control bush 410 of a fourth embodiment will be described. FIG. 10A is a cross-sectional view of the vibration control bush 410, and FIG. 10B is a partial side view of the vibration control bush 410 viewed in the arrow Xb direction of FIG. 10A. FIG. 10A illustrates a cross-sectional surface taken along the plane along the axis O, and FIG. 10B illustrates a bottom surface (a top) of a groove 425 by the dashed line.

As illustrated in FIG. 10A, the vibration control bush 410 includes the groove 425 formed in the main body portion 20. The groove 425 is a ring-shaped groove depressed toward the end surface 23 of the main body portion 20. The groove 425 is depressed toward the projecting portion 340 side along the outer peripheral surface of the inserted portion 30. That is, since the groove 425 is formed adjacent to the outer peripheral surface of the inserted portion 30, the stress generated at the boundary between the main body portion 20 and the inserted portion 30 can be reduced with the groove 425. This allows improving the durability of the vibration control bush 410.

As illustrated in FIG. 10B, the groove 425 includes curving portions 425a having a curved shape projecting toward the projecting portion 340 in a groove bottom surface and a linear portion 425b coupled to the curving portion 425a in the circumferential direction. Although the illustration will be omitted, a plurality of the curving portions 425a are circumferentially formed at regular intervals (four positions in the groove 425 in this embodiment), and end portions in circumferential direction of the plurality of curving portions 425a are coupled with the linear portions 425b. The linear portion 425b is a part where a depth of the groove 425 is constant along the circumferential direction.

That is, the groove 425 is formed in the curved shape corresponding to the depressed portion 327 of the main body portion 20, and a depth of the groove 425 in a state before the projecting portion 340 is compressed is formed to be constant in the circumferential direction. Accordingly, the depth of the groove 425 can be uniformed in the circumferential direction even after the projecting portion 340 is compressed. Accordingly, the stress generated at the boundary between the main body portion 20 and the inserted portion 30 can be effectively reduced with the groove 425.

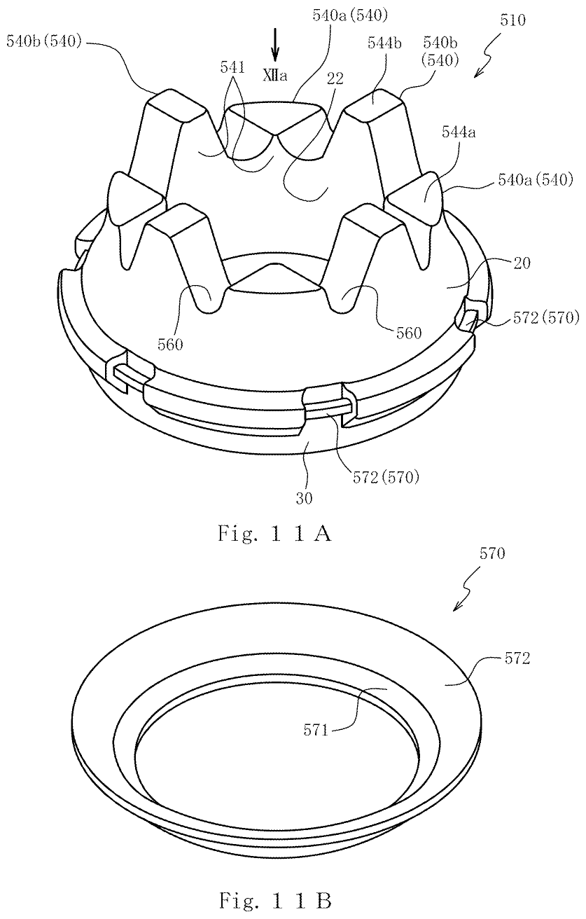

Although thus reducing the stress generated at the boundary between the main body portion 20 and the inserted portion 30 can be reduced with the groove 425, disposing a reinforcing member at the boundary part also allows reducing the stress. A vibration control bush 510 of a fifth embodiment having the configuration will be described with reference to FIG. 11 to FIG. 14.

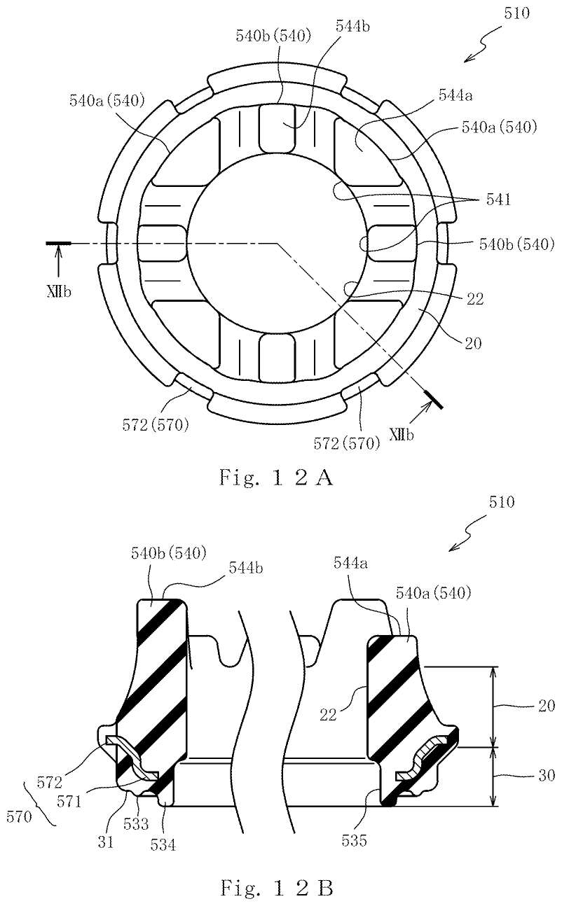

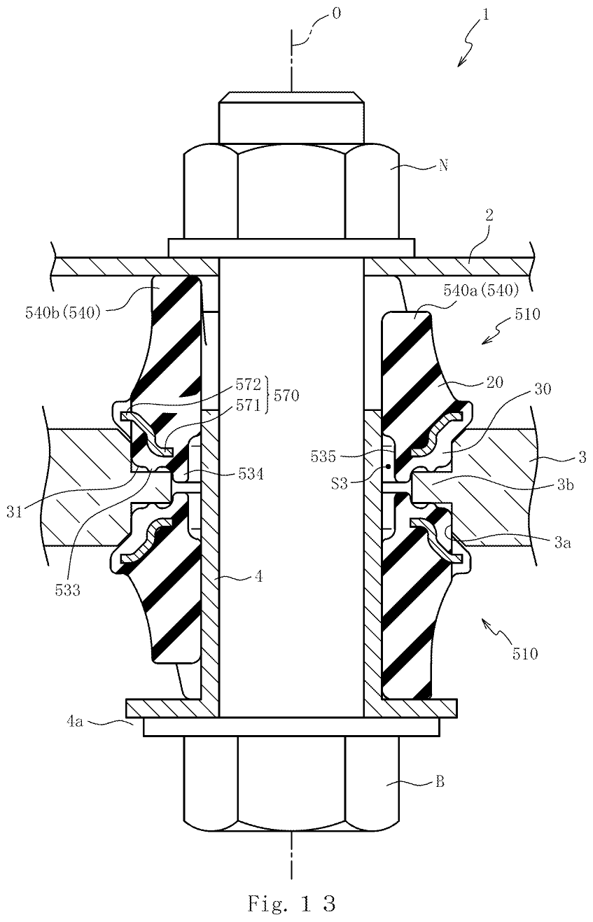

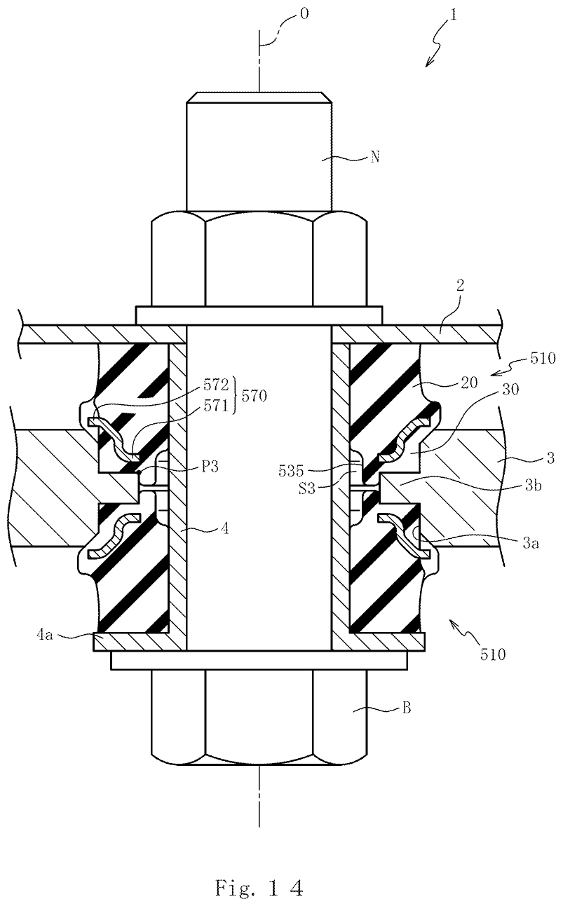

FIG. 11A is a perspective view of the vibration control bush 510 in the fifth embodiment, and FIG. 11B is a perspective view of a reinforcing member 570. FIG. 12A is a top view of the vibration control bush 510 viewed in the arrow XIIa direction of FIG. 11, and FIG. 12B is a cross-sectional view of the vibration control bush 510 taken along the line XIIb-XIIb of FIG. 12A. FIG. 13 is a cross-sectional view illustrating a state before the bolt B and the nut N are fastened in a fastening structure 501 using the vibration control bushes 510. FIG. 14 is a cross-sectional view illustrating a state in which the bolt B and the nut N are fastened in the fastening structure 501 using the vibration control bushes 510.

As illustrated in FIG. 11 and FIG. 12, projecting portions 540 are formed in an end surface on a side opposite to the inserted portion 30 in the axis O direction of the main body portion 20 of the vibration control bush 510 of the fifth embodiment. The projecting portion 540 is a projection projecting from the main body portion 20 in the axis O direction, and a plurality of (four in this embodiment) the projecting portions 540 are formed to be circumferentially arranged at regular intervals. In this embodiment as well, a part positioned between the plurality of projecting portions 540 will be described as a depressed portion 560. A bottom surface of the depressed portion 560 is equivalent to the end surface 21 of the main body portion 20 of the first embodiment.

The projecting portions 540 project along the inner peripheral surface 22 of the main body portion 20. That is, an inner peripheral surface 541 of the projecting portion 540 is formed along the inner peripheral surface 22 of the main body portion 20, and the inner peripheral surface 541 of the projecting portion 540 and the inner peripheral surface 22 of the main body portion 20 are linearly formed in a cross-sectional view (see FIG. 12) taken along a plane along the axis O. Accordingly, when the projecting portions 540 are compressed (see FIG. 13 and FIG. 14) by the vibration side member 2 (the flange portion 4a of the tubular member 4) and the support side member 3, the projecting portions 540 can compressed while causing the projecting portions 540 to run along the outer peripheral surface of the tubular member 4. Accordingly, even when the height of the projecting portion 540 is formed to be comparatively high, precompression can be appropriately given to the projecting portion 540.

The projecting portion 540 includes a plurality of (four in this embodiment) projecting portions 540a having comparatively low projection heights from the main body portion 20 and a plurality of (four in this embodiment) projecting portions 540b formed between the plurality of projecting portions 540a.

The projection height of the projecting portion 540b from the main body portion 20 is higher than the projecting portion 540a, thereby ensuring a large amount of compression of the projecting portion 540b (lengthening a compression length). Accordingly, even when the rubber of the main body portion 20 is deteriorated from the compressed state (the state in FIG. 14) of the projecting portions 540b to decrease an elastic force, restoring the compressed projecting portion 540b allows easily maintaining the contact state with the vibration side member 2 and the flange portion 4a of the tubular member 4.

Since the projecting portion 540a formed in the region between the plurality of projecting portions 540b is also compressed (see FIG. 13 and FIG. 14), the concentration of the stress generated by precompression only on the formation region of the projecting portion 540b can be suppressed. In other words, with the vibration control bush 510 in the assembled state (the state in FIG. 14), a reactive force (a spring force) generated by the compression of the projecting portions 540a and 540b can be uniformed in the circumferential direction.

An area of an end surface 544b of the projecting portion 540b in the axis O direction is formed smaller than an area of an end surface 544a of the projecting portion 540a. Accordingly, a contacted area of the vibration side member 2 (see FIG. 13 and FIG. 14) and the flange portion 4a of the tubular member 4 with the end surfaces 544b of the projecting portions 540b can be reduced. Accordingly, even when the rubber of the main body portion 20 deteriorates from the compressed state (the state in FIG. 14) of the projecting portions 540b to decrease the elastic force, and assume that the projecting portions 540b repeatedly contact and separate from the vibration side member 2, an abnormal noise generated by the repetitive contact can be reduced.

Since the end surfaces 544a and 544b of the projecting portions 540a and 540b are planes perpendicular to the axis O, forces when the projecting portions 540a and 540b are compressed are likely to be applied in the axis O direction. This allows suppressing falling of the projecting portions 540a and 540b toward the outer peripheral side when the projecting portions 540a and 540b are compressed.

A circumferential width dimension of the projecting portion 540a is formed to gradually increase from the inner peripheral side to the outer peripheral side. This allows suppressing the falling of the projecting portion 540a toward the outer peripheral side when the projecting portion 540a is compressed.

The plurality of projecting portions 540 are coupled one another with the depressed portions 560, and the depressed portion 560 radially extends from the outer peripheral surface to the inner peripheral surface 22 of the main body portion 20. Since the depressed portion 560 is a curved surface depressed toward the inserted portion 30 side, concentration of stress when the projecting portions 540 are compressed (the state in FIG. 14) on a region between the projecting portions 540, that is, a part of the depressed portions 560, can be suppressed. Accordingly, the durability of the vibration control bush 510 can be improved.

Although the illustration is omitted, processing equivalent to the low friction portion 24 (see FIG. 4B) of the first embodiment is performed on the inner peripheral surfaces 22 and 541 of the main body portion 20 and the projecting portions 540. Accordingly, the main body portion 20 and the projecting portions 540 easily slip with respect to the tubular member 4 (see FIG. 13 and FIG. 14) during the compression of the projecting portions 540, and therefore the projecting portions 540 can be appropriately compressed. Further, an abnormal noise due to the friction between the outer peripheral surface of the tubular member 4 and the inner peripheral surfaces 22 and 541 of the main body portion 20 and the projecting portions 540 can be suppressed.

The reinforcing member 570 is embedded into the main body portion 20 and the inserted portion 30. The reinforcing member 570 is formed in a ring shape using a material having a rigidity higher than that of the rubber elastic body constituting the vibration control bush 510, for example, resin and a metal. The reinforcing member 570 includes a ring-shaped covered portion 571 constituting a part on its inner edge side and an exposed portion 572 that projects out to the outside in the radial direction while extending from the outer edge side of the covered portion 571 to the main body portion 20 side, and the covered portion 571 and the exposed portion 572 are integrally formed.

The covered portion 571 is entirely covered with the inserted portion 30, and therefore the reinforcing member 570 is not exposed from the end surface 31 of the inserted portion 30. Accordingly, even when the load (the vibration) is repeatedly input in the axis O direction and the radial direction with the vibration control bushes 510 in the assembled state (the state in FIG. 14), detachment at the interface between the inserted portion 30 and the reinforcing member 570 (the covered portion 571) can be suppressed.

On the other hand, a part of the exposed portion 572 constituting the outer edge portion of the reinforcing member 570 is exposed from the outer peripheral surface of the main body portion 20. Both end surfaces of the exposed portion 572 in the axis O direction and the outer peripheral surface of the exposed portion 572 are exposed at the exposed portions from the main body portion 20. The exposed portions of the exposed portion 572 are parts to be supported to an inner surface of molds (sandwiched between an upper die and a lower die) during metallic molding of the vibration control bushes 510.

Thus, this embodiment has a configuration in which, while a part of the exposed portion 572 constituting the outer edge portion of the reinforcing member 570 is exposed from the outer peripheral surface of the main body portion 20, the other entire part (the covered portion 571) of the reinforcing member 570 excluding a part of the exposed portion 572 is embedded into the main body portion 20 and the inserted portion 30. Thus, the reinforcing member 570 can be exposed from the main body portion 20 in the region where stress is less likely to occur at the input of the load (the vibration) in the axis O direction. Accordingly, the detachment at the interface between the exposed portion (a part of the exposed portion 572) of the reinforcing member 570 and the main body portion 20 can be suppressed, and therefore the durability of the vibration control bush 510 can be improved.

An end portion of the covered portion 571 positioned on the side (the lower side in FIG. 12B) opposite to the main body portion 20 in the axis O direction bends radially inside. That is, in a cross-sectional view taken along a plane along the axis O, the covered portion 571 is formed in an L shape, and the reinforcing member 570 is entirely formed in an approximately S shape (a crank shape). Thus, when the load in the axis O direction is input with the vibration control bushes 510 in the assembled state (the state in FIG. 14), the deformation of the rubber toward the inner peripheral side of the reinforcing member 570 can be restricted by the bent portion of the covered portion 571. Accordingly, since the stress generated at the interface between the rubber and the reinforcing member 570 during the deformation of the rubber can be reduced, the durability of the vibration control bushes 510 can be improved.

As illustrated in FIG. 13 and FIG. 14, in the fastening structure 501 of this embodiment, a protrusion 3b is formed inside the through-hole 3a in the support side member 3. The protrusion 3b projects radially inside in the ring shape from the inner peripheral surface of the through-hole 3a, and has an inner diameter formed to be smaller than the outer diameter of the inserted portion 30. Accordingly, in the insertion state in which the inserted portion 30 is inserted into the through-hole 3a, the inserted portion 30 gets caught on the protrusion 3b.

In the insertion state, the covered portion 571 is disposed at a position overlapping with the protrusion 3b in the axis O direction. Thus, when the load in the axis O direction is input, displacement of the vibration control bush 510 (the deformation of the rubber) toward the inside of the through-hole 3a can be restricted by the catch of the protrusion 3b and the covered portion 571. This allows improving the spring constant in the axis O direction.

The reinforcing member 570 has an outer diameter formed larger than the inner diameter of the through-hole 3a. Accordingly, in the insertion state in which the inserted portion 30 is inserted into the through-hole 3a, the outer edge of the reinforcing member 570 (the exposed portion 572) gets caught on the edge portion of the through-hole 3a. Thus, when the load in the axis O direction is input, displacement of the vibration control bush 510 (the deformation of the rubber) toward the inside of the through-hole 3a can be restricted by the catch of the edge portion of the through-hole 3a and the reinforcing member 570 (the exposed portion 572). This allows improving the spring constant in the axis O direction.

A first ring-shaped projecting portion 533 projects from the end surface 31 (see FIG. 13) of the inserted portion 30. The first ring-shaped projecting portion 533 is formed in a ring shape viewed in the axis O direction, and is formed at a position overlapping with the covered portion 571 of the reinforcing member 570 in the axis O direction. Accordingly, with the projecting portions 540 (the main body portion 20) in the compressed state (the state in FIG. 14), the first ring-shaped projecting portion 533 is also compressed by being sandwiched between the covered portion 571 and the protrusion 3b of the support side member 3.

Thus, even when the rubber sandwiched between the covered portion 571 and the protrusion 3b is deteriorated and the elastic force decreases, restoration of the compressed first ring-shaped projecting portion 533 allows maintaining the contact state with the protrusion 3b. Accordingly, the repetitive contact and separation between the inserted portion 30 and the protrusion 3b when the load in the axis O direction is repeatedly input can be suppressed, and thus an abnormal noise due to repetitive contact can be suppressed.

A second ring-shaped projecting portion 534 is formed on the inner peripheral side with respect to the first ring-shaped projecting portion 533. The second ring-shaped projecting portion 534 is a ring-shaped projection projecting from the end surface 31 of the inserted portion 30, and has a projection height from the end surface 31 of the inserted portion 30 formed to be higher than that of the first ring-shaped projecting portion 533. The second ring-shaped projecting portion 534 is inserted into the inner peripheral side of the protrusion 3b. Accordingly, when the load (the vibration) in the axis O direction is repeatedly input with the vibration control bushes 510 in the assembled state (the state in FIG. 14), stress concentrates on a boundary P3 (see FIG. 14) between the first ring-shaped projecting portion 533 and the second ring-shaped projecting portion 534 and a crack is likely to occur.

In contrast to this, in this embodiment, an inner peripheral surface of the first ring-shaped projecting portion 533 and an outer peripheral surface of the second ring-shaped projecting portion 534 are coupled with a curved surface. That is, between the first ring-shaped projecting portion 533 and the second ring-shaped projecting portion 534, a ring-shaped groove depressed in a curved shape is formed. Accordingly, even when the load in the axis O direction is repeatedly input, the stress generated at the boundary P3 part between the first ring-shaped projecting portion 533 and the second ring-shaped projecting portion 534 can be reduced.

The protrusion 3b of the support side member 3 has an inner diameter formed larger than the inner diameter of the reinforcing member 570, and with the inserted portion 30 inserted into the through-hole 3a, an inner edge of the reinforcing member 570 (the covered portion 571) is positioned on the inner peripheral side (the tubular member 4 side) with respect to the protrusion 3b. Therefore, when the load in the axis O direction is input with the vibration control bushes 510 in the assembled state (the state in FIG. 14), the deformation of the rubber of the protrusion 3b toward the inner peripheral side can be restricted by the inner edge portion of the reinforcing member 570 (the covered portion 571). Thus, since the pushing of the second ring-shaped projecting portion 534 into the inner peripheral side of the protrusion 3b can be suppressed, even when the load in the axis O direction is repeatedly input, the stress generated at the boundary P3 part between the first ring-shaped projecting portion 533 and the second ring-shaped projecting portion 534 can be effectively reduced.

Here, with the inserted portion 30 inserted into the through-hole 3a, the covered portion 571 of the reinforcing member 570 is sandwiched between the inner peripheral surface of the through-hole 3a and the tubular member 4. In this case, as described above, when the end portion in the axis O direction of the covered portion 571 bends radially inside, the spring constant in the radial direction becomes excessively high in some cases.

In contrast to this, in this embodiment, the inserted portion 30 has an inner peripheral depressed portion 535 positioned on the inner peripheral side of the bent portion of the covered portion 571. The inner peripheral depressed portion 535 is a ring-shaped depression formed by notching the inner peripheral surface of the inserted portion 30. In the inner peripheral surface of the inserted portion 30, the inner peripheral depressed portion 535 is formed from the region where the inner peripheral depressed portion 535 overlaps with the covered portion 571 in the radial direction to the end portion in the axis O direction of the inserted portion 30 (the second ring-shaped projecting portion 534).

Thus, in the state before the projecting portion 540 (the main body portion 20) is compressed (the state in FIG. 13), a space S3 can be formed between the tubular member 4 and the inner peripheral surface of the inserted portion 30 by the inner peripheral depressed portion 535. In a state after the projecting portions 540 (the main body portion 20) are compressed (the state in FIG. 14), the deformation of the rubber is received at the space S3, and the space S3 is configured to remain in the inner peripheral side of the covered portion 571 in the compressed state as well. Accordingly, even when the end portion in the axis O direction of the covered portion 571 is bent radially inside, the excessive increase in the spring constant in the radial direction can be suppressed.

Here, as in this embodiment, in the configuration in which the reinforcing member 570 is embedded into the main body portion 20 and the inserted portion 30, when the projecting portions 540 are compressed, the rubber is less likely to deform outside in the radial direction in the region where the reinforcing member 570 is embedded. Accordingly, for example, when the outer diameter of the main body portion 20 is constant in the axis O direction in the state before the projecting portions 540 are compressed (the state in FIG. 13), the deformation is likely to occur such that only the region where the reinforcing member 570 is not embedded bulges outside in the radial direction. When only a part of the region thus bulges, stress is likely to concentrate on the deformed part, and the durability of the vibration control bush 510 deteriorates.

In contrast to this, in this embodiment, the outer diameter (the thickness dimension in the radial direction) of the main body portion 20 is formed so as to gradually increase as approaching the inserted portion 30 side, and therefore the outer diameter of the main body portion 20 with the projecting portions 540 compressed (the state in FIG. 14) can be easily constant in the axis O direction. This allows suppressing concentration of the stress during the compression of the projecting portions 540 on a part of the main body portion 20, thereby ensuring improving the durability of the vibration control bushes 510.

As described above, the present invention has been described based on the above-mentioned embodiments. It can be easily inferred that the present invention will not be limited to the embodiments described above by any means, but various modifications and improvements are possible within the scope not departing from the gist of the present invention.

While the description has been omitted in the respective embodiments, examples of ones configured as the vibration source of the vibration side member 2 include an electric motor, a gasoline engine, a diesel engine, a hydrogen fuel engine, a hydrogen motor, or a hybrid of them (for example, a hybrid of a gasoline engine and an electric motor), and examples of energy driving the vibration source include a fossil fuel, hydrogen, or electricity. However, as long as the vibration source (the vibration side member 2) and the member supporting the vibration source (the support side member 3) are fastened and secured with the bolt B and nut N, the vibration control bushes 10, 210, 310, 410, and 510 of the respective embodiments are applicable. Accordingly, the vibration source (the vibration side member 2) and the member supporting the vibration source (the support side member 3) are not limited to the above-described ones.

The configurations equivalent to the main body portion 20, the inserted portion 30, the projecting portion 40, 340, or 540 (the depressed portion 360 or 560), and the reinforcing member 570 of the vibration control bush 10, 210, 310, 410, or 510 of each of the embodiments may be applied to another embodiment. Accordingly, for example, the configuration equivalent to the outer periphery depressed portion 326 of the third embodiment may be applied to the vibration control bush 10, 210, or 510 of the first, second, or fifth embodiment. The configurations equivalent to the projecting portions 540a and 540b of the fifth embodiment may be applied to the vibration control bushes 10, 210, 310, and 410 of the first to the fourth embodiments. The same applies to the other configurations.

While the case where the vibration side member 2 is fastened and secured to the through-hole 3a in the support side member 3 via the vibration control bushes 10, 210, 310, 410, or 510 has been described in each of the embodiments, this should not be construed in a limiting sense by any means. For example, the configuration in which the support side member 3 is fastened and secured to the through-hole 2a in the vibration side member 2 via the vibration control bushes 10, 210, 310, 410, or 510 may be applied.

While the case where the four or eight projecting portions 40, 340, or 540 are formed has been described in each of the embodiments, this should not be construed in a limiting sense by any means. The number of projecting portions 40, 340, and 540 formed can be set appropriately.

While the case where the low friction portions 24 are formed in the respective inner peripheral surfaces of the main body portion 20, the inserted portion 30, and the projecting portions 40, 340, or 540 has been described in each of the embodiments, this should not be construed in a limiting sense by any means. For example, the low friction portion 24 may be formed only in any of the inner peripheral surfaces of the main body portion 20, the inserted portion 30, and the projecting portion 40, 340, or 540, or the low friction portion 24 may be omitted.

While the case where the inserted portions 30 of each of the pair of vibration control bushes 10, 210, 310, or 410 (two components) are inserted into the through-hole 3a in the support side member 3 has been described in the first to fourth embodiments, this should not be construed in a limiting sense by any means. For example, the inserted portions 30 of the pair of vibration control bushes 10, 210, 310, or 410 may be coupled to be integrally formed (one component).

While the case where the thickness dimension in the radial direction of the projecting portion 40 or 340 gradually increases as approaching the main body portion 20 has been described in the first to fourth embodiments, this should not be construed in a limiting sense by any means. For example, the thickness dimension in the radial direction of the projecting portion 40 or 340 may be constant in the axis O direction.

While the case where the thickness dimension in the circumferential direction of the projecting portion 40 or 540a is formed to gradually increase from the inner peripheral side to the outer peripheral side has been described in the first, second, or fifth embodiments, this should not be construed in a limiting sense by any means. For example, the thickness dimension in the circumferential directions of the projecting portion 40 or 540a may be constant from the inner peripheral side to the outer peripheral side, or may gradually decrease.

While the case where the depressed portion 360 or 560 positioned between the projecting portions 340 and 540 has the curved surface has been described in the third to fifth embodiments, this should not be construed in a limiting sense by any means. For example, a part of the depressed portion 360 or 560 may be formed in a plane perpendicular to the axis O.

While the case where the projecting portions 340 or 540 project along the inner peripheral surface 22 of the main body portion 20 has been described in the third to fifth embodiments, this should not be construed in a limiting sense by any means. For example, the projecting portions 340 and 540 may be formed on the outer edge side of the end surface in the axis O direction of the main body portion 20 (need not be formed along the inner peripheral surface 22), or the projecting portions 340 or 540 may be omitted, and the end surface in the axis O direction of the main body portion 20 may be formed in a plane.

While the case where the depressed portion 327 formed in the end surface 23 of the main body portion 20 and the depressed portion 32 formed in the end surface 31 of the inserted portion 30 are formed at the positions overlapping with the projecting portion 340 in the axis O direction has been described in the third and fourth embodiments, this should not be construed in a limiting sense by any means. For example, the depressed portion 32 or 327 may be formed at a position not overlapping with the projecting portion 340 in the axis O direction (need not be formed at the position having the same phase in the circumferential direction). The depressed portions 32 or 327 may be omitted, and the end surface 23 or 31 of the main body portion 20 or the inserted portion 30 may be formed in a flat surface.

While the case where the depth of the depressed portion 327 is deeper than the depth of the depressed portion 32 and the width dimension in the circumferential direction of the depressed portion 327 is formed to be larger than the width dimension in the circumferential direction of the depressed portion 32 has been described in the third and fourth embodiments, this should not be construed in a limiting sense. The depth and the width dimension of the depressed portion 327 may be same as those of the depressed portion 32, or the depth and the width dimension of the depressed portion 32 may be larger than those of the depressed portion 327.

While the case where the thickness dimension in the radial direction of the main body portion 20 in the region overlapping with the projecting portion 340 in the axis O direction is formed to be thinner than that in the other region has been described in the third and fourth embodiments, this should not be construed in a limiting sense by any means. For example, the thickness dimension in the radial direction of the main body portion 20 may be constant in the circumferential direction.

When the plurality of depressed portions 327 arranged in the circumferential direction are formed in the end surface 23 (the second end surface) of the main body portion 20, the parts positioned between the plurality of depressed portions 327 become the projecting portions (the projecting portions of the second end surface). In this case, the thickness dimension in the radial direction of the main body portion 20 in the region overlapping with the projecting portion in the axis O direction may be formed to be thinner than that in the other region. With this configuration, with the projecting portion of the end surface 23 (the second end surface) in the compressed state, the thickness in the radial direction of the main body portion 20 can be easily made constant in the circumferential direction. This allows suppressing the concentration of the stress during the compression of the projecting portions on a part of the main body portion 20.

While the case where the depth of the groove 225 in the region overlapping with the projecting portion 40 in the axis O direction is formed to be deeper than that in the other region has been described in the second embodiment, this should not be construed in a limiting sense by any means. For example, the depth of the groove 225 may be constant in the circumferential direction.

While the case where the depth of the groove 425 is constant in the whole circumference in the circumferential direction has been described in the fourth embodiment, this should not be construed in a limiting sense by any means. For example, the depth of the groove 425 may be the deepest in the region overlapping with the projecting portion 340 in the axis O direction.

While the case where the height of the projecting portion 540b is higher than the projecting portion 540a has been described in the fifth embodiment, this should not be construed in a limiting sense by any means. For example, the heights of the projecting portions 540a and 540b may be the same, or the height of the projecting portion 540a may be higher than the projecting portion 540b. Alternatively, the areas of the end surfaces 544a and 544b of the projecting portions 540a and 540b may be the same. The area of the end surface 544b of the projecting portion 540b may be larger than the end surface 544a of the projecting portion 540a.

While the case where the reinforcing member 570 is embedded into the main body portion 20 and the inserted portion 30 has been described in the fifth embodiment, this should not be construed in a limiting sense by any means. For example, the reinforcing member 570 may be embedded into only any one of the main body portion 20 and the inserted portion 30, or the reinforcing member 570 may be omitted.

While the case where the end portion of the covered portion 571 of the reinforcing member 570 is bent radially inside has been described in the fifth embodiment, this should not be construed in a limiting sense by any means. For example, the end portion of the covered portion 571 may be formed in a linear shape (a cylindrical shape) along the axis O direction.

While the case where the inner peripheral depressed portion 535 is formed on the inner peripheral side of the bent portion of the covered portion 571 has been described in the fifth embodiment, this should not be construed in a limiting sense by any means. For example, the inner peripheral depressed portion 535 may be omitted.

While the case where the outer diameter of the main body portion 20 is formed to increase as approaching the inserted portion 30 side has been described in the fifth embodiment, this should not be construed in a limiting sense by any means. For example, the outer diameter of the main body portion 20 may be constant in the axis O direction.

While the case where the protrusion 3b is formed in the support side member 3 of the fastening structure 501 has been described in the fifth embodiment, this should not be construed in a limiting sense by any means. For example, the protrusion 3b in the support side member 3 of the fastening structure 501 may be omitted.

A configuration equivalent to the protrusion 3b may be applied to the support side member 3 of the fastening structure 501 according to the first to fourth embodiments, and the inserted portion 30 of the vibration control bush 10, 210, 310, or 410 may get caught on the protrusion 3b. This configuration allows improving the spring constant in the axis O direction.

While the case where the first ring-shaped projecting portion 533 and the second ring-shaped projecting portion 534 are formed in the end surface 31 of the inserted portion 30 has been described in the fifth embodiment, this should not be construed in a limiting sense by any means. For example, any one of both of the first ring-shaped projecting portion 533 and the second ring-shaped projecting portion 534 may be omitted, and the end surface 31 of the inserted portion 30 may be formed to be a plane.

While the case where, when the inserted portion 30 is inserted into the through-hole 3a, the inner edge of the reinforcing member 570 is positioned on the inner peripheral side with respect to the protrusion 3b has been described in the fifth embodiment, this should not be construed in a limiting sense by any means. For example, in the insertion state, a configuration in which the inner edge of the reinforcing member 570 is positioned on the outer peripheral side with respect to the inner edge (the distal end) of the protrusion 3b (the inner diameter of the reinforcing member 570 is larger than the inner diameter of the protrusion 3b) may be used.

### DESCRIPTION OF REFERENCE NUMERALS

1,501: fastening structure
2: vibration side member (washer)
3: support side member (fastened member)
3a: through-hole (through-hole of the fastened member)
3b: protrusion
4: tubular member
4a: flange portion (washer)
10,210,310,410,510: vibration control bush
20: main body portion
21: end surface (first end surface)
22: inner peripheral surface of the main body portion
23: end surface (second end surface)
24: low friction portion
225,425: groove
327: depressed portion of the main body portion
30: inserted portion
31: end surface
32: depressed portion of the inserted portion
535: inner peripheral depressed portion
40,340,540: projecting portion
540a: projecting portion (first projecting portion)
544a: end surface
540b: projecting portion (second projecting portion)
544b: end surface
570: reinforcing member
571: covered portion
572: exposed portion
B: bolt
N: nut
O: axis

1. A vibration control bush comprising
a rubber elastic body configured as a component of any one of a vibration source side and a support side, the vibration control bush being interposed between a pair of washers in a fastening structure,
wherein the fastening structure includes a fastened component having a through-hole, a cylindrical tubular member being inserted into the through-hole in the fastened component, a pair of the washers being disposed on both end sides in an axis direction of the tubular member, and a bolt and a nut being fastened to one another with the pair of washers sandwiched therebetween,
wherein the vibration control bush is formed in a cylindrical shape including a main body portion and an inserted portion, the main body portion is compressed between the fastened component and the washer during the fastening of the bolt and the nut, and the inserted portion is inserted into the through-hole,
the main body portion has a first end surface and a second end surface, the first end surface is positioned on the washer side in an axis direction, and the second end surface is on a side opposite to the first end surface,
a plurality of projecting portions arranged in a circumferential direction are formed in at least one of the first end surface and the second end surface, and
a thickness dimension in a radial direction of the main body portion in a region overlapping with the projecting portion in the axis direction is formed thinner than a thickness dimension in another region.

2. The vibration control bush according to claim 1,
wherein the thickness dimension in the radial direction of the main body portion is formed to be a thickest in a region between the plurality of projecting portions in a circumferential direction and is formed to be a thinnest in the region overlapping with the projecting portion in the axis direction.

3. The vibration control bush according to claim 2,
wherein in the first end surface, a plurality of projecting portions arranged in the circumferential direction are formed,
in the second end surface, a plurality of depressed portions arranged in the circumferential direction are formed, and
the depressed portion of the main body portion is formed at a position overlapping with the projecting portion of the main body portion in the axis direction.

4. The vibration control bush according to claim 3,
wherein a pair of the vibration control bushes are disposed with the fastened member interposed therebetween,
the inserted portion has a plurality of depressed portions formed in an axial end surface of the inserted portion and arranged in a circumferential direction, and
the depressed portion of the main body portion and the depressed portion of the inserted portion are formed at positions arranged in the axis direction when viewed in the radial direction.

5. The vibration control bush according to claim 4,
wherein the depressed portion of the main body portion has a depth deeper than a depth of the depressed portion of the inserted portion, and
the depressed portion of the main body portion has a width dimension in the circumferential direction formed larger than a width dimension of the depressed portion of the inserted portion in the circumferential direction.

6. The vibration control bush according to claim 1,
wherein the main body portion has an inner peripheral surface in which a low friction portion having a friction coefficient lower than a friction coefficient of the rubber elastic body is formed.

7. The vibration control bush according to claim 1,
wherein the first end surface has a plurality of projecting portions arranged in the circumferential direction, and
the projecting portions project along an inner peripheral surface of the main body portion, and when the projecting portions are compressed by the washers, the projecting portions and the tubular member are contactable.

8. The vibration control bush according to claim 7,
wherein the projecting portion has a thickness dimension in a circumferential direction formed to gradually increase from an inner peripheral side to an outer peripheral side.

9. The vibration control bush according to claim 8,
wherein the projecting portion has a thickness dimension in a radial direction formed to gradually increase as approaching the main body portion.

10. The vibration control bush according to claim 1,
wherein the first end surface has a plurality of projecting portions arranged in the circumferential direction,
the plurality of projecting portions include a first projecting portion and a second projecting portion having a height from the first end surface higher than a height of the first projecting portion, and
the first projecting portion is formed between a plurality of the second projecting portions in the circumferential direction.

11. The vibration control bush according to claim 10,
wherein an axial end surface of the second projecting portion has an area formed to be smaller than an area of an axial end surface of the first projecting portion.

12. The vibration control bush according to claim 1,
wherein the first end surface has a plurality of projecting portions arranged in the circumferential direction,
the main body portion has a ring-shaped groove formed in the second end surface, and
the groove is formed adjacent to an outer peripheral surface of the inserted portion.

13. The vibration control bush according to claim 12,
wherein the groove in a region overlapping with the projecting portion in an axis direction has a depth formed to be deeper than a depth in another region.

14. The vibration control bush according to claim 1,
wherein a ring-shaped reinforcing member having a rigidity higher than a rigidity of the rubber elastic body is embedded into the main body portion and the inserted portion, and
the reinforcing member includes a covered portion and an exposed portion, the covered portion constitutes a part on an inner edge side of the reinforcing member and is entirely covered with the inserted portion, and the exposed portion constitutes a part on an outer edge side of the reinforcing member with respect to the covered portion and is exposed from an outer peripheral surface of the main body portion.

15. The vibration control bush according to claim 14,
wherein the covered portion has an end portion positioned on a side opposite to the main body portion side in the axis direction, and the end portion is bent radially inside.

16. The vibration control bush according to claim 15,
wherein the inserted portion has an inner peripheral depressed portion positioned on an inner peripheral side of the bent portion of the covered portion and depressed to an inner peripheral surface of the inserted portion.

17. The vibration control bush according to claim 14,
wherein when a protrusion projecting from an inner peripheral surface of the through-hole toward the tubular member side is formed in the fastened member, the covered portion is disposed at a position overlapping with the protrusion in the axis direction.

18. The vibration control bush according to claim 17,
wherein the inserted portion has a first ring-shaped projecting portion that projects from an axial end surface of the inserted portion and is formed in a ring shape when viewed in an axis direction, and
the first ring-shaped projecting portion is formed at a position overlapping with the covered portion in an axis direction.

19. The vibration control bush according to claim 17,
wherein when the inserted portion is inserted into the through-hole, an inner edge of the reinforcing member is positioned on an inner peripheral side with respect to the protrusion.
